(19) United States
(12) Patent Application Publication
(10) Pub. No.: US 2008/0258509 A1
(43) Pub. Date: Oct. 23, 2008

(54) Vehicle Roof With a Roof Part Mounted Movably on a Central Guide

(76) Inventors: Thomas Schutt, Furstenfeldbruck (DE); Michael Respondek, Munchen (DE)

Correspondence Address: DICKINSON WRIGHT PLLC, 1901 L. STREET NW, SUITE 800, WASHINGTON, DC, 20036, US

(21) Appl. No.: 11/917,246

(22) PCT Filed: Jun. 8, 2006
(86) PCT No.: PCT/DE06/00985

§ 371 Date: Dec. 12, 2007

(30) Foreign Application Priority Data
Jun. 9, 2005 (DE) 10 2005 026 827.7

(51) Int. Cl. B60J 7/047

(52) U.S. Cl. 296/220.01

(57) ABSTRACT

The invention relates to a vehicle roof with at least a first roof part (4) and a second roof part (5), the first roof part (4), for the longitudinal movement on the vehicle roof (2), being manned displacably on a longitudinally directed centre guide (10, 12, 13) of the vehicle roof (2) by means of a first hearing device (14, 15, 17) and on the second roof part (5) by means of a second bearing device (22, 23) and being movable between a closed position covering the vehicle interior and an open position, in which it is at least partially arranged over the second roof part (5), and, in order to improve the functionality, the invention making provision for the centre guide (10, 12, 13) to be mounted longitudinally movable manner on the second roof part (5) and in to be displaceable between its bearing position, in which it provides a mounting for the first roof part (4), and its storage position, in which it is moved into the second roof part (5) when the first roof part (4) is open.

The invention relates to a vehicle roof with at least one first roof part and a second roof part, with the first roof part being mounted in movable fashion on the second roof part for a longitudinal movement on the vehicle roof by means of a first bearing mechanism on a longitudinal central guide of the vehicle roof and being movable between a closed position covering the interior space of the vehicle and an open position in which it is at least partially arranged above the second roof part.

Such a vehicle roof which is known, for example, from JP 03114925 or JP 62286829 is also referred to as “T-bar roof” It contains a central guide permanently attached to the roof that connects the windshield cowl to the rear, firmly attached roof section. The roof section is movably mounted in its front central area by means of a slide on the central guide and by lateral rear mounting devices on lateral guides firmly attached to the roof.

The invention is based on the task of improving the aforementioned vehicle roof with regard to its functionality.

This task is solved in the above-mentioned vehicle roof in accordance with the invention by the fact that the central guide is mounted in longitudinally movable fashion on the second roof part and that it is adjustable between its bearing position, in which it provides a bearing for the first roof part, and its storage position in which it is moved into the second roof part with the first roof part being open. Advantageous embodiments of the invention are listed in the subclaims.

By means of the design of the vehicle roof in accordance with the invention, a partial opening of the roof can be fixed by moving the first roof part above the adjacent second roof part, with the central guide which, for example, is formed as a bar, girder or mounting beam, taking over the support of the first roof part in its, for example, front middle section prior to the opening of the first roof part; during the opening; and also with the first roof part being open. This makes a lateral frontal mounting and support of the first roof part unnecessary, and lateral longitudinal beams at least in the area of the closed first roof part are not required for bearing purposes. The vehicle roof is therefore suited for convertibles with a completely detachable roof as well as for vehicles with fixed roof sections, such as, for example, with fixed lateral longitudinal roof beams in which at least parts of the roof are adjustable from a closure position covering the passenger compartment to a repository position.

By removing the central guide from the roof opening allocated to the first roof part or from the corresponding exposable roof area of a convertible, the field of vision is extended correspondingly. In particular in the case of a convertible, a compact unit composed of the roof parts and the central guide that can be stored in the storage space in space-saving fashion is created by relocating the central guide to the second roof part.

Even though the special advantages such as a roof opening position of the kind of an open Targa® roof are particularly present in the case of a convertible, the vehicle roof in accordance with the invention can be applied in advantageous fashion in vehicles with at least partially fixed vehicle roots, in which the first movable roof part can be arranged adjustably from a closure position covering a roof opening towards the front as well as towards the rear via adjacent fixed or movable roof parts or roof sections and in which consequently the central guide is displaceable towards the front as well as towards the rear and into or under adjacent roof sections or roof parts.

The central guide can always assume a hearing function of the adjustable first roof part. Alternatively, the first roof part can be decoupled from the central guide during its opening position and can be completely supported by the second roof part.

Preferably, the second bearing device contains two bearing units lying opposite each other and being arranged in the lateral border area that are mounted slidably in assigned guides of the second roof part that are open towards the top and that can be covered, if necessary. A stable three-point bearing of the first roof part is thereby created. However, the rear bearing device may also be arranged closer to the roof center and have at least one bearing unit on at least one assigned guide of the second roof part.

Thus, this vehicle roof offers many different opportunities for a variable roof design and corresponding opening of the roof in vehicles with fixed lateral roof pillars or in convertibles with detachable roofs.

In the following, the vehicle roof is described in detail by way of an example of an embodiment with reference to the drawing. Shown are:

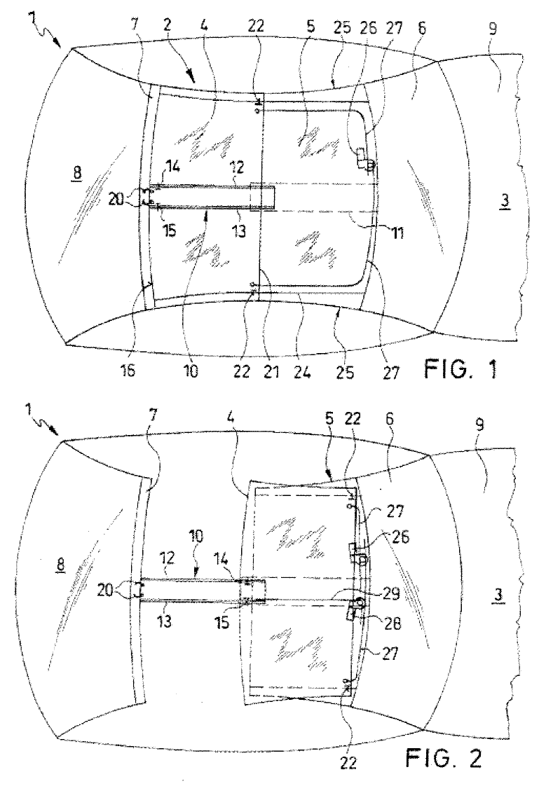

FIG. 1: in a top view in a schematic representation, a vehicle roof in accordance with the invention of a convertible vehicle roof in closed position;

FIG. 2: in a top view in accordance with FIG. 1, the vehicle roof, with a front roof part being displaced rearward over a central roof part;

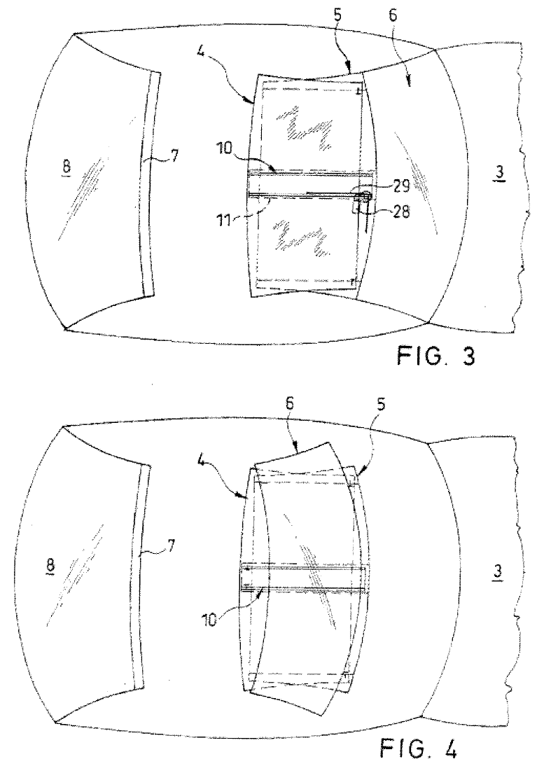

FIG. 3: in a top view in accordance with FIG. 2, the vehicle roof, with a central guide of the front roof part being retracted under the central roof part;

FIG. 4: in a top view in accordance with FIG. 3, the vehicle roof, with the rear roof part being relocated via the front and central roof parts.

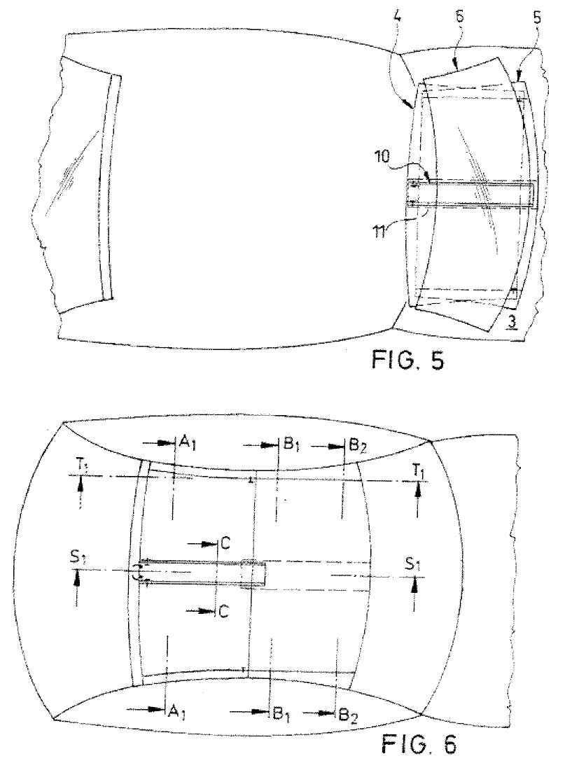

FIG. 5: in a top view in accordance with FIG. 4, the vehicle roof, with the roof package consisting of the three roof parts having been swung into the storage space:

FIG. 6: in a top view in accordance with FIG. 1, the closed vehicle roof with an indication of the position of the cross sections of the following figures;

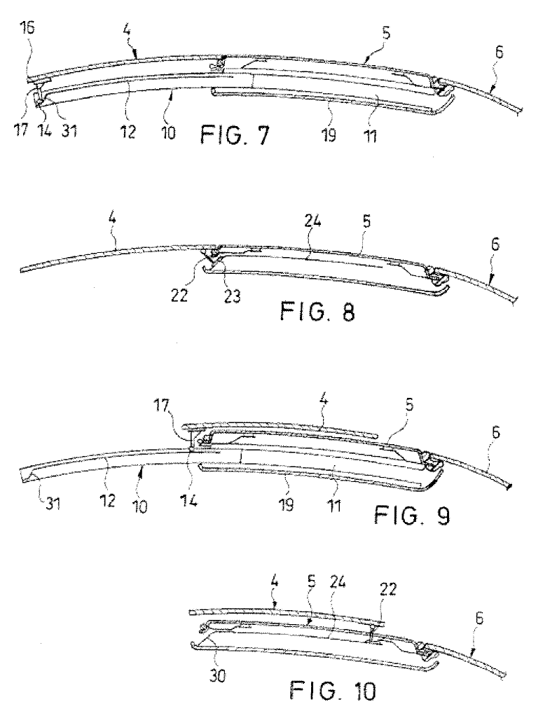

in FIG. 7 the closed vehicle roof in a sectional view along the line S₁-S₁, in FIG. 6;

FIG. 8: the closed vehicle roof in a sectional view along the line T₁-T₁ in FIG. 6;

FIG. 9: the vehicle roof with the front roof part open in a sectional view along the line S₁-S₁ in FIG. 6;

FIG. 10: the vehicle roof with the front roof part open in a sectional view along the line T₁-T₁ in FIG. 6;

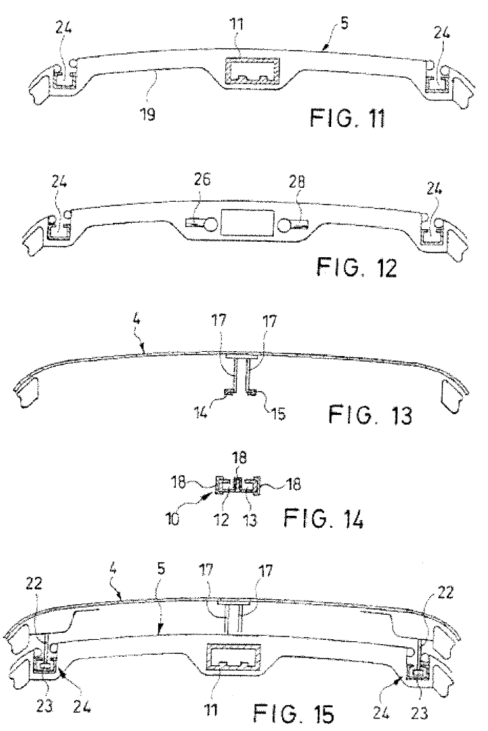

FIG. 11: the central roof part of the vehicle roof in a sectional view along the line B₂-B₂ in FIG. 6;

FIG. 12: the central roof part of the vehicle roof in a sectional view along the line B₂-B₂ in FIG. 6;

FIG. 13: the frontal roof part of the vehicle roof in a sectional view along the line A₁-A₁ in FIG. 6;

FIG. 14: in a sectional view along the line C-C in FIG. 6, the center guide of the frontal roof part;

FIG. 15: in a sectional view along the line C-C in FIG. 6, the frontal roof part of the vehicle roof in its open position above the central roof part.

A convertible vehicle 1 (see FIG. 1, schematic representation only) contains a movable and, for opening purposes, retractable roof 2 that is adjustable in known fashion between a closed position covering the vehicle interior (FIG. 1) and an open or storage position (FIG. 5) in which it is deposited in a storage space or top receptacle 3. In accordance with the embodiment as represented, the roof 2 is a movable hardtop with a frontal roof part 4, a central roof part 5 and a rear roof part 6 which contains a rear window. The fixed roof parts 4, 5 and 6 are arranged behind each other in the closed position, with the frontal roof part 4 abutting a windshield cowl 7 above the windshield 8 and being connected to the central roof part 5, the central roof part 5 being mounted laterally in rotatable fashion, in each case via a quadruple joint, on the vehicle body, and the rear roof part being mounted on the central roof part 5 or its bearing mechanism, abutting a top receptacle 9 or a trunk cover in closed position and being pivoted during the storing process of the roof 2 above the two frontal and central roof parts 4 and 5 that are arranged above each other before all roof parts are deposited rearward as one single unit. With regard to the fundamental design and mode of operation of the roof 2, reference is made to DE 101 50 219 A1 which shows such a roof.

The frontal roof part 4 is mounted movably by means of a first bearing mechanisms on a bearing beam 10 containing a center guide and on the central roof part by means of a second bearing mechanism. The bearing beam 10 is arranged centrally and in longitudinal direction on the vehicle roof and mounted movably on the central roof part 5 in a guide 11 that is formed as a closed bearing profile, for example.

The support bar 10 is, for example, executed as a light metal profile rail containing to adjacent guides 12 and 13 for allocated rolls or slides 14 or, respectively, 15 that are arranged on a support arm 17 sticking out downward from the frontal roof part 4 in the area of its front edge. Synthetic layers 18 are applied on the support bar 10 or, respectively, on the light metal profile rails (see FIG. 14), that form skidding surfaces for the movement of the support bar 10 or, respectively, of the profile rail relative to the guide 11 and for the movement of the sliders 14 and 15 along the guides 12 and 13. The guide 11 of the support bar 10 is arranged on the underside of the central roof part 5 and covered by an internal canopy 19 of the central roof part.

A lock mechanism 20 is provided that keeps the support bar 10 locked at its frontal end in its frontal storage position (see FIG. 1) along the windshield cowl 7. Activation of the locking mechanism 20 which has at least one lock element arranged on the windshield cowl 7 or on the support bar 10 may occur manually or by means of a drive. Such locking mechanisms or, respectively, locking elements are generally known with regard to folding or convertible roofs

The second bearing device is allocated to the rear border 21 of the frontal roof part 4 and contains on each side a support arm sticking out downward from the frontal roof part 4 that is guided movably by means of a slider in a lateral guide 24 that is arranged on the upper side of the central roof part 5 in proximity of its lateral edge 25 and that essentially runs across the entire length of the central roof part 5.

A drive mechanism for the frontal roof part 4 contains a drive motor 26 (see FIGS. 1, 2 and 12) that is arranged on the underside of the central roof part 5 next to the guide 11 and that is connected to the frontal roof part on both sides via two drive cables that are rigid with regard to pull and push. A drive mechanism for the central guide or, respectively, for the support bar 10 contains a drive motor 28 (see FIGS. 3 and 12) which is likewise arranged on the underside of the central roof part 5 and next to the guide opposite the drive motor 26 of the frontal roof part 4 and that is connected to the support bar 10 via a drive cable that is rigid with regard to pull and push. Both drive motors 26 and 28 are covered by the interior canopy 11 on the underside.

For the opening of the closed vehicle roof 2 (FIG. 1), the frontal roof part 5 is transported rearward over the central roof part 4 by means of the drive motor 26. To this end, the two rear bearing arms 22 that are mounted rotatably around a transversal axis on the frontal roof part 4 and that are folded backward when the frontal roof part is closed, are erected via their slide shoes or slides 23 that are guided upward along an ascending frontal rail section 30 of the respective lateral guide 24 and then transitioning into the horizontal course of the lateral guide 24 along a rail curvature. The frontal roof part 4 is then supported by means of its two rear bearing arms 22 at a distance to the central roof part 5 and can be relocated in the manner of an externally guided sun roof cover over the central roof part 5 (see EP 0 863 817 31 which shows an externally guided sun roof cover). During the initial rearward movement of the frontal roof part 4, the frontal bearing arms 17 that are fixed to the frontal roof part are lifted by means of their sliders 14, 15 along an ascendant frontal rail section 31 of the two guides 12, 13 and subsequently moved backward in the horizontal section of the guides 12, 13. The frontal roof part 4 can be retracted to its rear open position above the central roof part 5 for a complete release of the allocated roof opening (see FIG. 2 as well as 9 and 10, Targa® position), or it can be positioned in an interim position for a partial release of the roof opening. In this, the support bar 10 or, respectively, the central guide strengthens the partially opened vehicle roof 2.

For a complete opening and storing of the entire roof 2 in the storage space or the top receptacle 3, the locking mechanism is activated and unlocked with the roof 2 in a position in accordance with FIG. 2. Subsequently the drive motor 28 is activated and the support bar 10 is moved rearward into the receptacle and thus under or, respectively, into the central roof part 5 (see FIG. 3).

Thereupon the rear roof part 6 is rotated towards the front above the frontal roof part 4 which is already arranged above the central roof part 5, and this roof part package is rotated following the opening of the top of the covered box 9 by means of the main bearing mechanism into the storage space or covered box 3 (see DE 101 50 219 A1). Thus, the convertible is completely open, with the roof 2 stored away. The closing of the roof occurs in the opposite course of movements.

### LIST OF REFERENCE MARKS

1 Convertible vehicle
2 Roof
3 Top receptacle
4 Frontal roof part
5 Center roof part
6 Rear roof part
7 Windshield cowl
8 Windshield
9 Top receptacle lid
10 Support bar
11 Guide
12 Guide
13 Guide
14 Slider
15 Slider
16 Front edge
17 Bearing arm
18 Synthetic layer
19 Interior canopy
20 Locking mechanism
21 Rear edge
22 Support arm
23 Slide
24 Lateral guide
25 Lateral border
26 Drive motor
27 Drive cable
28 Drive motor
29 Drive cable
30 Frontal track section
31 Frontal track section

1. Vehicle roof with at least one front roof part and a center roof part, with the front roof part being movably mounted for a longitudinal movement on the vehicle roof by means of a first bearing device on a longitudinally directed center guide of the vehicle roof and by means of a second bearing device on the second roof part, and being movable between a closed position covering the vehicle interior and an open position in which it is at least partially arranged above the second roof part,
characterized by the fact that, in order to improve the functionality, the invention provides for the center guide (10, 12, 13) to be mounted on the second roof part (5) for a longitudinal movement and to be adjustible between its bearing position in which it provides a bearing for the front roof part (4) and its storage position in which it is moved into the second roof part (5) with the front roof part (4) being open.

2. Vehicle roof in accordance with claim 1, characterized by the fact that the central guide (10, 12, 13) in its bearing position
extends through a roof area closable by the front roof part (4) or such an opening and
that it is detachably attached to an additional part of the vehicle roof or body part, in particular by means of a locking mechanism (20).

3. Vehicle roof in accordance with claim 1 or claim, characterized by the fact that the central guide (10, 12, 13) will always assume a bearing function of the adjustable front roof part (4) or that the front roof part (4) in its open position is uncoupled from the central guide (10, 12, 13).

4. Vehicle roof in accordance with one of claims 1 through 3, characterized by the fact that the central guide (10, 12, 13) can be retracted into a guide (11) that is arranged in or on the second roof part (5).

5. Vehicle roof in accordance with one of claims 1 through 4, characterized by the fact that the first bearing mechanism is arranged on a first in particular frontal transverse edge of the first roof part (4; and the second bearing mechanism, on an opposite second in particular rear transverse edge of the first roof part (4).

6. Vehicle roof in accordance with claim 5, characterized by the fact that the second bearing mechanism has two opposed bearing units arranged in the area of the lateral edge of the first roof part (4) which units are movably mounted in allocated guides of the second roof part (5) that are open at the top.

7. Vehicle roof in accordance with one of claims 1 through 6, characterized by the fact that a drive mechanism (28, 29) coupled with the central guide (10, 12, 13) and a drive mechanism (26, 27) coupled with the first roof part (4) are arranged on the second roof part (5).

8. Vehicle roof in accordance with one of claims 1 through 7, characterized by the fact that the first roof part and the second roof part area frontal roof part (4) and a central or, respectively, rear roof part (5) of a convertible vehicle and that the central guide (10, 12, 13) in its storage position is attached to a windshield cowl above a front pane (8).

9. Vehicle roof in accordance with one of claims 1 through 8, characterized by the fact that it has a first frontal roof part (4), a second central roof part (5) and a third rear roof part (6) of which the first frontal roof part (4) can be moved above the second roof part (5), that the central guide (10) can be accepted by the central roof part (5) and the rear roof part (6) can be moved across the two roof parts arranged on top of each other, and that this roof package can be deposited into a storage space of the convertible.

10. Vehicle roof in accordance with one of claims 1 through 9, characterized by the fact that the central guide (10) is a profile rail, in particular one made of a light metal, and that it has synthetic sliding surfaces (18) for its storage surfaces.
